(19) United States
(12) Patent Application Publication
(10) Pub. No.: US 2023/0289909 A1
(43) Pub. Date: Sep. 14, 2023

(54) A METHOD FOR MONITORING THE ACADEMIC PROGRESS OF A USER

(71) Applicant: IBUILDPRO HOLDINGS LIMITED, London (GB)

(72) Inventors: Keano CHANG, London (GB); Allar AHTMANN, London (GB)

(73) Assignee: IBUILDPRO HOLDINGS LIMITED, London (GB)

(21) Appl. No.: 18/008,117

(22) PCT Filed: May 27, 2021
(86) PCT No.: PCT/GB2021/051307

§ 371 Date: Dec. 2, 2022

(30) Foreign Application Priority Data
Jun. 4, 2020 (GB) 2008415.8

(51) Int. Cl. G06Q 50/20; G06Q 10/105

(52) U.S. Cl. CPC G06Q 50/205; G06Q 10/105

(57) ABSTRACT

The present invention relates to a computer implemented method for monitoring the academic progress of a user comprising the method steps of: allowing the user to create a user profile containing verifiable data; recording the verifiable data to a central resource; cross checking an item of verifiable data with a reference source; recording data associated with the result of the cross check to the central resource; and associating the user profile with an educator.

### FIELD OF THE INVENTION

The present invention relates to a computer implemented method for monitoring the academic progress of a user. The present invention further relates to a data processing apparatus for carrying out the computer implemented method. The present invention also relates to a computer program for causing a computer to carry out the computer implemented method. The present invention further relates to a computer-readable medium for causing a computer to carry out the computer implemented method.

### BACKGROUND TO THE INVENTION

Enrolment in training and educational programmes is advantageous to improve the knowledge, skills and confidence of a person or persons, entering or within the workforce. Such educational programmes often require successful completion of a number of inter- and extra-curricular tasks or projects, and monitoring academic progress of a student can be challenging.

Failure to monitor a student's academic progress can be detrimental to both the student and the educator providing the educational programme, as successes can go unrecorded and incomplete work may go unnoticed. Additionally, if a student's journey through an educational programme has been ill documented, verification of achievements, goals and performance is challenging. In this way, there is a need to accurately record and monitor the academic progress of a student undertaking an education programme.

Additionally, students leaving such programmes may lack confidence in their industry knowledge or feel poorly equipped upon completion of the programme. There is a further need to encourage students to participate in non-compulsory educational projects to improve their skills and confidence, and to support the student upon completion of the educational programme.

Embodiments and aspects of the present invention seek to address at least the above problems of the prior art.

### SUMMARY OF THE INVENTION

According to a first aspect of the present invention there is provided a computer implemented method for monitoring the academic progress of a user comprising the method steps of: allowing the user to create a user profile containing verifiable data; recording the verifiable data to a central resource; cross checking an item of verifiable data with a reference source; recording data associated with the result of the cross check to the central resource; and associating the user profile with an educator.

In this way there is advantageously provided a method for reliable recording and monitoring a user's academic progress to a central resource. Such a resource is of great advantage when considering those looking to enter the workforce. Not only is a verified data profile regarding the user built, but an accurate log of the user's educational progress is also recorded to the central resource, and can be used as proof in the user's post-education professional progression. Such a resource is also advantageous when considering persons and professionals already in the work force looking to improve their skills and knowledge.

Preferably, the method comprises cross checking an item of verifiable data against a plurality of reference sources. More preferably, the method comprises cross checking a plurality of items of verifiable data against a plurality of reference sources.

Preferably, the method comprises the further step of: retrieving at least one educational pathway associated with the educator from the central resource, and assigning the at least one educational pathway to the user; wherein the educational pathway comprises at least one task for completion by the user.

Preferably, the method comprises prompting the user to complete the at least one task within the at least one educational pathway. Preferably, the method further comprises issuing an alert if the at least one task is not completed within at least one predetermined time period. Preferably, the at least one predetermined time period is retrieved from the central resource. Preferably, the at least one educational pathway comprises the at least one predetermined time period.

Preferably, the method comprises the steps of; identifying at least one incomplete task within the educational pathway; and communicating the task and its status to at least one third party.

Preferably, the method comprises the steps of allowing the user to mark at least one task within the educational pathway as complete, and recording the completion of the at least one task in the central resource. Preferably, the method further comprises cross checking the completion of the at least one task with the or the at least one reference source; and recording data associated with the result of the cross check to the central resource. Preferably, the method further comprises recording data associated with the completion of the at least one task to the central resource.

Preferably, the method comprises cross checking the data associated with the completion of the at least one task; and recording data associated with the result of the cross check to the central resource.

Preferably, the method the steps of; retrieving a list of tasks associated with the at least one educational pathway from the central resource; retrieving a list of tasks completed by the user from the central resource; comparing the two lists; and recording the completion of the educational pathway in the central resource if the user has completed a predetermined number of tasks associated with the educational pathway.

Preferably, the or the plurality of reference sources comprises a third-party database. Preferably, the or the plurality of reference sources comprises the central resource. Preferably, the or the plurality of reference sources comprises information provided by a customer, manager or quality controller. Preferably, the or the plurality of reference sources comprises information provided by a second user. In this way, information regarding groups and teams of users can be gathered.

Preferably, the method further comprises recording the association between the user and the second user in the central resource. Preferably, the method further comprises the step of defining a predetermined relationship status to the association between the user and the second user and recording this relationship in the central resource.

According to a second aspect of the present invention there is provided a data processing apparatus comprising means for carrying out the method according to the first aspect of the invention.

According to a third aspect of the present invention there is provided a computer program comprising instructions which, when the program is executed by a computer, cause the computer to carry out the method according to the first aspect of the present invention.

According to a fourth aspect of the present invention there is provided a computer-readable medium comprising instructions which, when executed by a computer, cause the computer to carry out the method of the first aspect of the present invention.

### DETAILED DESCRIPTION

Embodiments of the present invention will now be described by way of example and with reference to the accompanying drawings, in which:

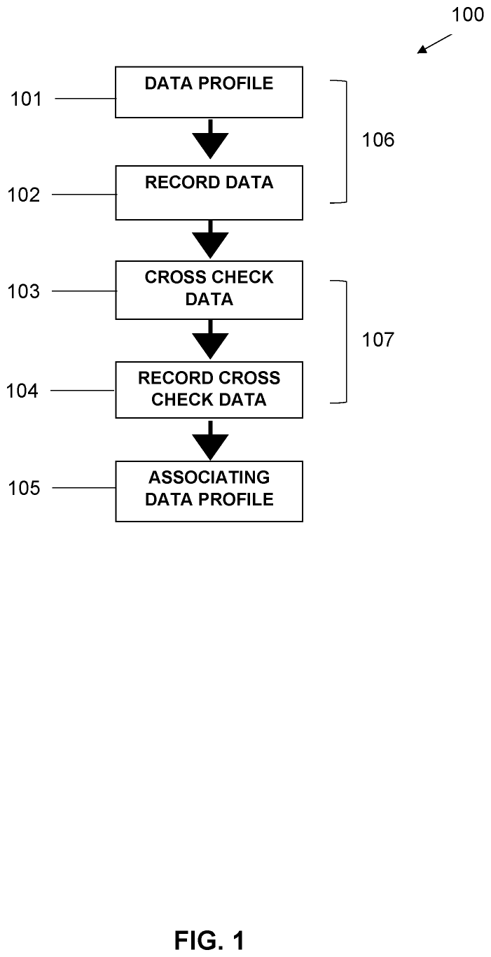

FIG. 1 is a schematic view of a computer implemented method according to the first aspect of the present invention;

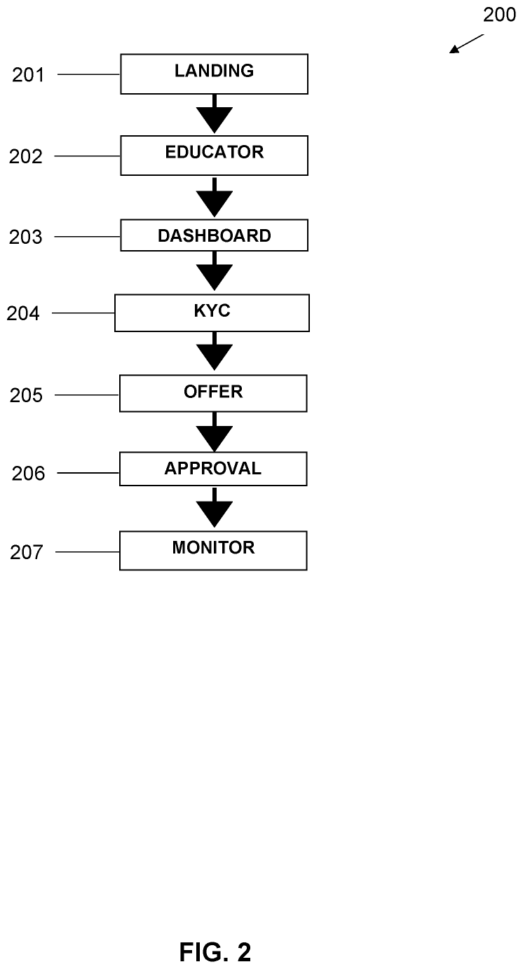

FIG. 2 is a schematic view of a second embodiment of the computer implemented method of FIG. 1, according to the first aspect of the present invention;

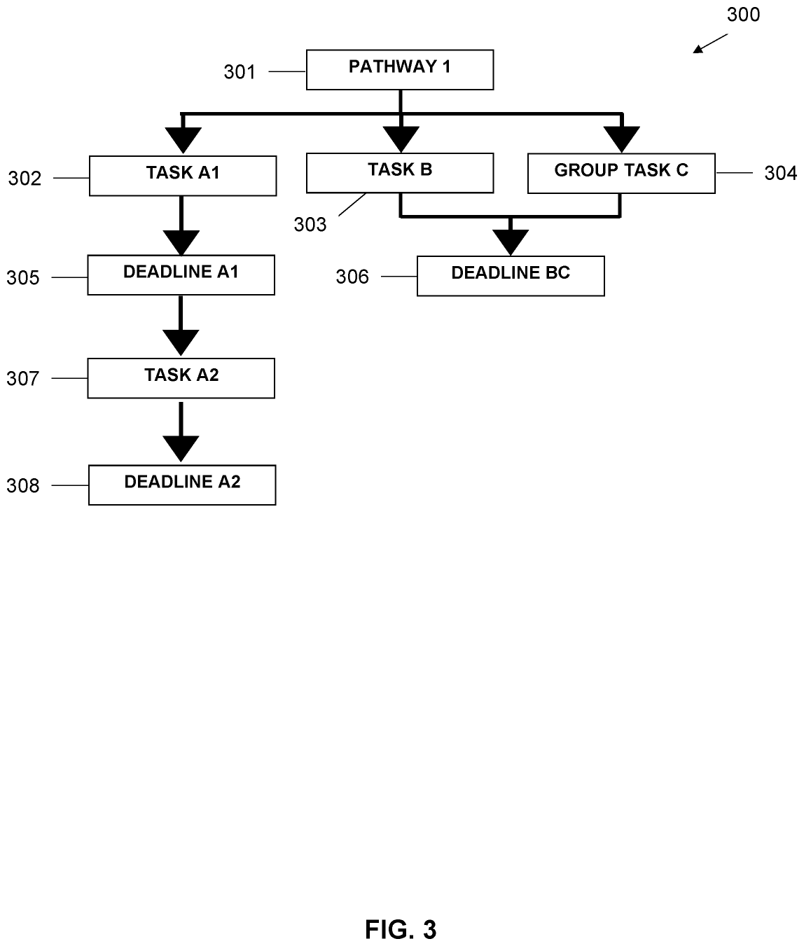

FIG. 3 is a schematic view of an educational pathway according to the first aspect of the present invention; and

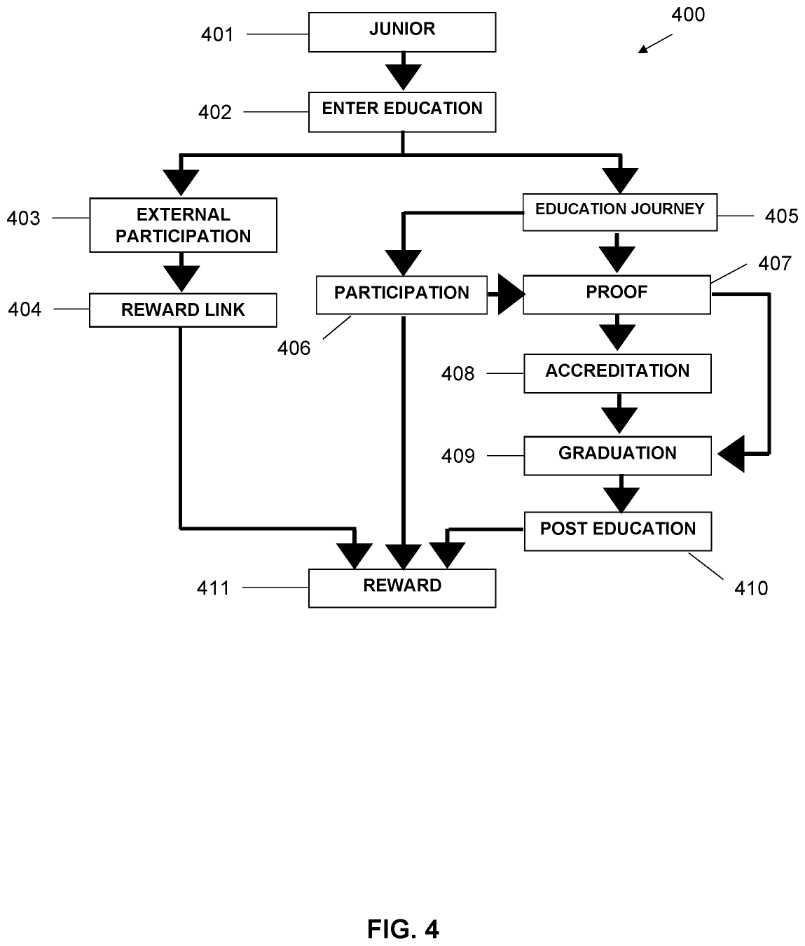

FIG. 4 is a schematic view of a rewards system in accordance with a third embodiment of the computer method of FIG. 1, according to the first aspect of the invention.

Herein, the method is described in relation to a student enrolled in an educational programme at University X, but it is envisaged that the method and related technology can also be applied to any educator on an individual or group basis. It is understood that an educator may be an individual, company, organisation, education facility, such as a school, college or university, or any suitable third party that provides a level of education or training to a user.

Referring firstly to FIG. 1, there is shown schematic view of a computer implemented method 100, according to the first aspect of the invention. The method 100 allows a user to provide data for verification and associates this data with an educator such that the academic progress of the user can be monitored. This allows a central resource of verified data to be built such that accurate information regarding the user's progress can be recorded and monitored.

The first step of the method 100 is a DATA PROFILE step 101. Herein, the user is allowed to create a profile containing verifiable data. For example, this data can be in the form of; personal data, such a name, age and contact details; data on an educator, such as name, address and website; data regarding a professor, teacher or mentor; data regarding an educational programme, such as a course start date; data regarding an educational pathway or task; and data concerning others, such as a second user or a previous educator. The data contained in the user profile may be provided in the form of documentation, such as ID or certificates, hyperlinks to websites and images. In this example, the verifiable data is the user's name and confirmation of accepted entry of the user on to an educational programme at University X.

The next step of the method 100 is a RECORD DATA step 102, wherein the verifiable data is recorded to a central resource, such as a central database or central ledger. The user's name and data regarding the acceptance of the user onto the programme are recorded onto the central resource. The DATA PROFILE step 101 and RECORD DATA step 102 form the PROVIDE phase 106 of the method 100.

Following this, a CROSS CHECK DATA step 103 comprises cross checking an item of verifiable data with a reference source. In this example, the reference source is an official database of students accepted onto the programme provided by the educator, University X. The CROSS CHECK DATA step 103 determines whether the user's name is found on the acceptance database and cross checks this with the data provided by the user in the DATA PROFILE step 101. The CROSS CHECK DATA step 103 provides a result, either that the provided user data is correct, or that the provided user data is incorrect.

The data associated with the result of the CROSS CHECK DATA step 103 is recorded to the central resource in a RECORD CROSS CHECK DATA step 104. In this way, the central resource comprises both the user-provided data and the cross checked data. The CROSS CHECK DATA step 103 and the RECORD CROSS CHECK DATA step 104 form the CROSS CHECK phase 107 of the method 100.

A benefit of cross checking and confirming a user's credentials is that a profile of factual, accurate user information can be built; improving reliability of the user's credentials and ensuring a truthful user profile is created.

Next, the data profile of the DATA PROFILE step 101 is associated with an educator in an ASSOCIATING DATA PROFILE step 105 such that the data profile is linked to the educator in the central resource. This allows the user data to be collated, verified, recorded and associated with an educator in a central resource, such that all data is stored collectively and monitoring of academic progress can occur.

With reference to FIG. 2, there is provided a schematic view of a further embodiment of the computer implemented method according to the first aspect of the present invention. The method 200 comprises the stages undertaken such that a user's academic progress can be monitored. The method 200 stages are carried out on a computer via user access to a software and or website platform. It is envisaged that the method 200 stages may be undertaken in an alternative order to that presented in the embodiment.

The method 200 comprises a number of PROVIDE phases 106, CROSS CHECK phases 107 and ASSOCIATING DATA PROFILE steps 105 in accordance with the embodiment of FIG. 1. The method 200 allows a user profile of verified data to be built and further associated with an educator, University X, such that academic progress can be monitored.

The first stage of the method 200 is a LANDING stage 201 comprising a DATA PROFILE step 101 as outlined in the embodiment of FIG. 1. The user inputs a plurality of data to a landing page of the software and or website platform, such as their educational programme category, location, email address and password. This allows a user profile to be created and accessed by the user.

There follows an EDUCATOR stage 202, wherein the user is requested to provide data regarding the educator, University X, such as the educator name, educator address and educator website. The data provided by the user in the method 200 can then be associated with University X in a series of ASSOCIATING DATA PROFILE steps 105 such that the verifiable data recorded in the following stages of the method 200 are also associated with University X. It is equally envisaged that the EDUCATOR stage 202 may occur at a different stage in the method 200.

There follows a DASHBOARD stage 203 wherein the data inputted in the LANDING stage 201 is recorded to a central resource. In this way, a reward or affiliate wallet of the user's data is created in the central resource. The DASHBOARD stage 203 further comprises the verification of user contact details, such as sending an email containing a hyperlink to the user's email address through which the user may verify this email address.

Next, a KNOW YOUR CUSTOMER (KYC) stage 204 is initiated. The KYC stage 204 comprises a PROVIDE phase 106 as outlined in the first embodiment. Herein, the user is allowed to input verifiable data, such as their name, age, address and data regarding tuition or course fees and payment. Further, the user may be requested to provide proof of this data in the form of official documentation, such as a copy of an ID, passport, driving license or financial or funding documentation. This data is recorded to the central resource such that a general wallet of the user's data is created in the central resource. The KYC stage 204 also comprises an ASSOCIATING DATA PROFILE step 105, wherein the profile of verifiable data is associated with University X.

The KYC stage 204 further comprises a CROSS CHECK phase 107, wherein the verifiable data provided in the PROVIDE phase 106 is cross checked against a reference source, and the result of the cross check is recorded on the central database. For example, the data regarding the user's funding of tuition fees are cross checked against a third-party database, such as an official database of students receiving funding from a third party loans company or written approval from an employer for funding the education programme. Each item of verifiable data is cross checked against a plurality of reference sources, where available, to improve accuracy and reliability of the data stored on the central resource in the method 200. If the verifiable data fails to correspond with the reference source, this is recorded on the central resource.

If appropriate for the user, there follows an OFFER stage 205 comprising another PROVIDE phase 106. It may be appropriate for the OFFER stage 205 to be initiated if the user had to meet a set of criteria for entry to the educational programme or if enrolment to the educational programme was undertaken. Herein, the user provides verifiable data regarding confirmation of enrolment to the programme and proof that requirements for enrolment have been met, with this data being recorded to the central resource. The user may provide verifiable data in the form of an admin email, professor or tutors email, student email, course start date, programme of study, year of study, and campus of study (if applicable).

The OFFER stage 205 comprises a CROSS CHECK phase 107 wherein the data is cross checked against the corresponding official enrolment records. Additionally, the OFFER stage 205 comprises a second PROVIDE phase 106, wherein the user is asked to provide a copy of an official confirmation letter or other proof corresponding to the data given in the first PROVIDE phase 106. It may be requested that this data be uploaded to the software and or website platform for further cross checking against reference sources.

The OFFER stage 205 may optionally comprise a sponsor step within the PROVIDE phase 106. A sponsor step may be appropriate if the user is newly affiliated with the educator, if the user is attending on behalf of an organisation or company or wherein financial assistance is being provided by a third party. The sponsor may be any appropriate third party such as an employer, previous educator or third party offering financial aid. In the sponsor step of the OFFER stage 205, the user is prompted to provide data regarding a sponsor or sponsors such as a sponsor name and a sponsor email.

The sponsor step comprises contacting the or each sponsor and requesting confirmation that the information provided by the user in the PROVIDE phase 106 of the OFFER stage 205 is correct. Further, the sponsor may be asked to confirm that verifiable data provided by the user in other stages of the method 200 is correct. This can be done by emailing the sponsor a form to complete and return. The form is hosted on the software and or website platform and is linked to the user such that the data provided by the user and the data provided by the sponsor are linked in the central resource. User action is not required regarding the sponsor form after the PROVIDE phase 106 of the OFFER stage 205, such that the sponsor may provide a truthful response to the form without risk of prejudice or pressure from the user.

Additionally, the sponsor may be requested to provide personal or financial information and data regarding themselves or the organisation they represent, similar to that which is provided by the user in the KYC stage 204. The data provided by the sponsor forms a reference source and is recorded on the central resource.

It is envisaged that the EDUCATOR stage 202 may alternatively follow the OFFER stage 204 in the method 200.

An APPROVAL stage 206 follows wherein the user data profile is approved by an administrator, professor or other person associated with the educator. The data associated from each of the previous stages wherein the user data profile is cross checked and validated is collated for approval. Alternatively or additionally, the APPROVAL stage 206 may comprise a sponsor step, such as that of the OFFER stage 205 to further cross check and verify the user provided verifiable data.

The educator, University X, is made aware if the data recorded on the central resource regarding the result of each CROSS CHECK phase 107 is not satisfactory, namely that the user provided data is not verified. The educator or person acting on behalf of the educator may then act accordingly.

There follows a MONITOR stage 207, wherein the user, educator or a third party may monitor the academic progress of the user. Herein, the method 200 further comprises the step of retrieving the relevant educational pathways associated with the educator from the central resource and assigning them to the user. FIG. 3, depicts an embodiment of an educational pathway 300 in accordance with the first aspect of the invention, which is assigned to the user in the MONITOR stage 207 of the method 200 of FIG. 2.

All educational pathways associated with the educator are stored on the central resource for ease of assignment to a user. Each educational pathway comprises at least one task for completion by the user. The pathways and tasks depend on the educator and the education provided by the educator. In the example of FIG. 3, PATHWAY 1 301 is a module on Course X at University X.

With reference to FIG. 3, Pathway 1 301 comprises four tasks. The user is initially prompted to complete three tasks: TASK A1 302, TASK B 303 and GROUP TASK C 304.

TASK A1 302 has a deadline for completion, DEADLINE A1 305. The user must complete each and every task by the deadline in order to meet successfully fulfil the requirements of the educational pathway 300. The time from prompting the user to complete TASK A1 302 to DEADLINE A1 205 is a predetermined time period retrieved from the central resource.

If TASK A1 302 is incomplete at the end of the predetermined time period, this data is recorded onto the central resource wherein the status is identified as incomplete. A third party, such as the professor leading the module, is notified that TASK A1 302 is incomplete. Additionally, the status of each task alongside the task may be available to the user, educator or third party continuously or this information may be communicated periodically. In this way, user failure to meet deadlines and complete tasks may be acknowledged and acted upon by the use, educator or third party. Therein is an incentive for the user to complete the tasks of the educational pathway 300 within the predetermined time period.

The user can mark a task in the educational pathway 300 as complete in a PROVIDE phase 106. Task completion is recorded in the central resource. The user verifiable data, namely that TASK A1 302 is complete, is then cross checked with a reference source in a CROSS CHECK phase 107 and associated with University X in an ASSOCIATING DATA PROFILE step 105. The data is cross checked with a number of reference sources where possible and the result of the CROSS CHECK phase 107 is recorded to the central resource.

The nature of the reference source is dependent on the nature of the task. For example, the reference source may comprise the central resource. In this way, the educator can record who has completed tasks and store this information on the central resource to cross check and verify that user task completion has occurred. Alternatively, the reference source may comprise a third-party data base, such as the attendance role of a sat examination.

The reference source may comprise information provided by a customer, manager or quality controller. A quality controller may be a specific party authorised to assess the quality of any given work or service. Alternatively, quality controller may be interpreted as any third party that verifies the quality of work or service, preferably based on selected criteria. For example, a quality controller may be a professor marking a piece of work, an examiner or the lead in a practical task.

Completion of TASK A1 302 prompts the user to complete TASK A2 307 by a predetermined deadline, DEADLINE A2 308. Data associated with all tasks is recorded, cross checked and associated with University X in a similar manner to TASK A1 302 with the method 100 of FIG. 1.

TASK B 303 and GROUP TASK C 304 share a mutual predetermined deadline for completion, DEADLINE BC 306.

GROUP TASK C 304 is a group task wherein the user must work with a second user to complete the task. Upon marking GROUP TASK C 304 as complete, this data provided by the user is cross checked with a database of users who have submitted work in relation to GROUP TASK C 304. Additionally, the user provided data is cross checked with data provided by a second user, namely the second member of the group. The second user confirms whether they and the user worked together on the task, assisting in verifying that the user has completed GROUP TASK C 304.

The association between the user and the second user is defined from a list of predetermined relationship status and recorded to the central resource. In this instance the defined relationship is ‘group member’ however any suitable association may be defined on the central resource, such as ‘lab partner’, ‘placement partner’, ‘tutor/tutee’, ‘professor/student’, ‘project manager/student’, ‘examiner/student’ or ‘mentor/mentee’.

In this way, data regarding the association between the user and the second user as well as data regarding the tasks and educational pathways completed together by the users is recorded on the central resource. The user, educator, other users or third parties can view the data regarding this association. This is beneficial for a user and second user who go on to, for example, become business partners, upon completion of the educational programme. Additionally, this data may be used to assist in better selection of user pairings or grouping of users, both during the educational programme and post completion of the educational programme.

The educational pathway 300 of the MONITOR stage 207 further comprises the steps; retrieving a list of tasks associated with PATHWAY 1 301, retrieving a list of tasks completed by the user from the central resource, comparing the two lists and recording the completion of the educational pathway 300 in the central resource is the user has completed the predetermined number of tasks associated with PATHWAY 1 301. Additionally, the list may be compared to a plurality of different lists, the results of the comparisons being recorded on the central resource.

In this way, an overall indicator of the user's academic progress is recorded on the central resource and it is easy for the user, educator or third party to broadly assess user progress.

The MONITOR stage 207 comprises all the educational pathways relevant to the users academic profile. The user, educator or third party may access some or all of the data stored in the central resource to assess and monitor the user's academic progression.

With reference to FIG. 4, there is provided a schematic view of a rewards system 400 in accordance with a third embodiment of the computer implemented method of FIG. 1.

Such an embodiment is particularly appropriate for users who are new to a profession or industry and have a low skill set or level of knowledge associated with the profession. The stages of the rewards system 400 allow a user to progress and monitor their educational progress during the educational programme and post completion. The rewards system rewards completion of compulsory activities, such as educational pathways and tasks within the educational programme, as well as participation in non-compulsory, supplementary projects and tasks such that professional development is encouraged. In this way, the user is encouraged to participate in tasks and projects that improve their business, professional and education development, regardless of whether such tasks are mandatory or not. As such, the user is encouraged to develop key skills for example, practical skills or business skills, such as skills regarding tax, cash flow management, marketing, human resource management, licensing and permits and financial planning. In this way, the user is better prepared with the skills they may need post completion of the educational programme.

The user begins the system in a JUNIOR stage 401. Herein the user may be an apprentice, intern, recent school graduate or other user with low experience in the area of education. The example in this embodiment considers an apprentice builder undergoing an educational programme.

The user enrolls and enters an educational programme in an ENTER EDUCATION stage 402. Herein the user enrolls with an educator such as a college, university or general training provider organisation or individual. The ENTER EDUCATION stage 402 comprises one or more of the stages of the method 200 of FIG. 2.

Upon completion of the ENTER EDUCATION stage 402, there are a number of pathways to achieve rewards, wherein the user may complete some or all of the pathways. Rewards may be financial such that they may be redeemed against educational programme and material costs, tuition costs or loans, costs outside of the educational programme, such as user rent or travel, or be put towards maintenance and infrastructure work carried out in the education facility. The rewards may take the form of a points system such that points accumulate towards a goal wherein acknowledgment is issued in the form of a recognisable award that is desirable to future employers. Alternatively or additionally, the rewards system may rank each user. In this way, the user, educator, other users and third parties, such as employers, customers, clients and homeowners, may view a user's ranking. Therein, a user is provided with motivation to achieve a high ranking.

The user can follow a first path, wherein an EXTERNAL PARTICIPATION stage 403 is initiated. The EXTERNAL PARTICIPATION stage 403 comprises one or more of the stages of the method 200 of FIG. 2. In this way, the user is directly onboarded by the educator and may participate in one or more third party reward projects to earn rewards, such as assisting on a third party renovation project.

A reward wallet is created for the user and associated with the educator on the central resource. The user's progress towards, as well as achievement of, rewards is recorded on the central resource. In this way, an overview of all users academic and reward progress is recorded to the central resource for monitoring and comparison against other users.

This is followed by a REWARD LINK stage 404. The user embarks on a third party reward project in the EXTERNAL PARTICIPATION stage 403 and, upon successful completion of the project, the educator or third party project leader is provided with a means to confirm that the project is complete and the user should be rewarded in the REWARD LINK stage 404. For example, a hyperlink is shared with the third party project leader to activate the user's reward.

There follows a REWARDS stage 411, wherein it is recorded on the central resource that the user has earned a reward. The provision of the reward is automated. In this way, the user is automatically provided with a reward, or the educator or a third party are notified that the user has earned a reward such that further manual action may be taken by the educator or a third party to provide the user with said reward.

Alternatively, there may be initiated an EDUCATION JOURNEY stage 405 following the ENTER EDUCATION stage 402. The EDUCATION JOURNEY stage 405 comprise one or more of the stages of the method 200 of FIG. 2 and the educational pathway 300 of FIG. 3. In the EDUCATION JOURNEY stage 405, users are able to see the progress of their education journey towards formal accreditations and or associations. This facilitates the user in directing their education towards new opportunities and projects such that the educational programme is tailored to the user's personal objectives.

Following this stage, if appropriate, there is initiated a PARTICIPATION stage 406 wherein the user is prompted to participate in educator reward programmes and projects. These may be non-compulsory, supplementary educational opportunities that the educator is providing or such tasks may be compulsory but with a choice as to which reward programme or project is selected by the user. In this way, the user is made aware of supplementary opportunities to their educational programme such that educational benefit is gained, or the user can make a better selection given the improved monitoring of their educational progress towards a personal objective. In this example, the educator rewards project is participating in repair work about the grounds of the educational facility or in the community.

Next, the user may progress to the REWARD stage 411, wherein the user earns a reward for participating in the educator reward programme or project.

Alternatively, the user may progress to a PROOF stage 407. Herein, the educator hires a contractor to undertake the repair work and the user assists the contractor on the project to earn rewards and gain experience. The contractor or user therein provides proof of participation in the educator rewards project.

There follows, if appropriate to the user, an ACCREDITATION stage 408 wherein the user is linked towards accreditation and associations. The user provides proof of accreditation and proof of association membership and this is cross checked and recorded on the central resource. This stage is appropriate to users entering a workforce requiring accreditation or professional membership.

If the ACCREDITATION stage 408 is not appropriate, there is initiated a GRADUATION phase 409, wherein the user leaves or graduates from the educational programme upon successful completion of the programme.

A POST EDUCATION phase 410 follows, with the user being provided with business and project management tools and features to assist in post education progression. The user data profile on the central resource is maintained such that the user retains a full portfolio of the academic and reward progression, as well as a data profile of cross checked and verified credentials. The user may additionally use their reward progress to obtain a ranking against other users. Further, additional assistance and resources are made available to the user, such as branding support and support in setting up a new business, in the POST EDUCATION phase 410 to assist the user's professional development and progress upon completion of the education programme.

There follows the REWARD stage 411 wherein the user is rewarded for successful completion of the educational programme.

1. A computer implemented method for monitoring the academic progress of a user comprising the method steps of:
allowing said user to create a user profile containing verifiable data;
recording the verifiable data to a central resource;
cross checking an item of verifiable data with a reference source;
recording data associated with the result of the cross check to the central resource; and
associating the user profile with an educator.

2. The computer implemented method of claim 1, wherein the method comprises cross checking an item of verifiable data against a plurality of reference sources.

3. The computer implemented method of claim 1 or claim 2, wherein the method comprises cross checking a plurality of items of verifiable data against a plurality of reference sources.

4. The computer implemented method of any one preceding claim, wherein the method comprises the further step of:
retrieving at least one educational pathway associated with the educator from the central resource, and
assigning the at least one educational pathway to the user; wherein
the educational pathway comprises at least one task for completion by the user.

5. The computer implemented method of claim 4, wherein the method comprises prompting the user to complete the at least one task within the at least one educational pathway.

6. The computer implemented method of claim 5, wherein the method further comprises issuing an alert if the at least one task is not completed within at least one predetermined time period.

7. The computer implemented method of claim 6, wherein the at least one predetermined time period is retrieved from the central resource.

8. The computer implemented method of claim 7, wherein the at least one educational pathway comprises the at least one predetermined time period.

9. The computer implemented method of any one of claims 4 to 8, wherein the method further comprises the steps of;
identifying at least one incomplete task within the educational pathway; and
communicating the task and its status to at least one third party.

10. The computer implemented method of any one of claims 4 to 9 comprising the steps of allowing the user to mark at least one task within the educational pathway as complete, and
recording the completion of the at least one task in the central resource.

11. The computer implemented method of claim 10, wherein the method further comprises cross checking the completion of the at least one task with the or the at least one reference source; and
recording data associated with the result of the cross check to the central resource.

12. The computer implemented method of claim 10 or claim 11, wherein the method further comprises recording data associated with the completion of the at least one task to the central resource.

13. The computer implemented method of claim 12, wherein the method further comprises cross checking the data associated with the completion of the at least one task; and
recording data associated with the result of the cross check to the central resource.

14. The computer implemented method of any one of claims 10 to 13, comprising the steps of;
retrieving a list of tasks associated with the at least one educational pathway from the central resource;
retrieving a list of tasks completed by the user from the central resource;
comparing the two lists; and
recording the completion of the educational pathway in the central resource if the user has completed a predetermined number of tasks associated with the educational pathway.

15. The computer implemented method of any one preceding claim, wherein the or the plurality of reference sources comprises a third-party database.

16. The computer implemented method of any one preceding claim, wherein the or the plurality of reference sources comprises the central resource.

17. The computer implemented method of any one preceding claim, wherein the or the plurality of reference sources comprises information provided by a customer, manager or quality controller.

18. The computer implemented method of any one preceding claim, wherein the or the plurality of reference sources comprises information provided by a second user.

19. The computer implemented method of claim 18, wherein the method further comprises recording the association between the user and the second user in the central resource.

20. The computer implemented method of claim 19, wherein the method further comprises the step of defining a predetermined relationship status to the association between the user and the second user and recording this relationship in the central resource.

21. A data processing apparatus comprising means for carrying out the method of any one preceding claim.

22. A computer program comprising instructions which, when the program is executed by a computer, cause the computer to carry out the method of any one of claims 1 to 20.

23. A computer-readable medium comprising instructions which, when executed by a computer, cause the computer to carry out the method of any one of claims 1 to 20.
